(19) United States
(12) Patent Application Publication
(10) Pub. No.: US 2010/0094846 A1
(43) Pub. Date: Apr. 15, 2010

(54) Leveraging an Informational Resource for Doing Disambiguation

(76) Inventor: Omid Rouhani-Kalleh, Santa Clara, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/371,410

(22) Filed: Feb. 13, 2009

Related U.S. Application Data
(63) Continuation-in-part of application No. 12/251,146, filed on Oct. 14, 2008.

(51) Int. Cl. G06F 17/30

(52) U.S. Cl. 707/705; 707/E17.055

(57) ABSTRACT

A method and apparatus for disambiguating a word or phrase is provided. Keywords are detected in a text. The keywords are each associated with one or more objects, and the objects are each categorized into one or more categories. Correlation values are retrieved from a correlation matrix to determine the frequency with which the categories co-occur. Based on the correlation values, a first category and a second category are selected for a first keyword and a second keyword. A first object associated with the first category can then be selected as the likely meaning for the first keyword. A second object associated with the second category can then be selected as the likely meaning for the second keyword. Content is sent to the client based on any of the first keyword, the first object, the first category, the second keyword, the second object, and the second category.

### CROSS-REFERENCE TO RELATED APPLICATIONS; BENEFIT CLAIM

This application claims benefit as a Continuation-in-part of application Ser. No. 12/251,146, filed Oct. 14, 2008, the entire contents of which is hereby incorporated by reference as if fully set forth herein, under 35 U.S.C. §120. The applicant hereby rescinds any disclaimer of claim scope in the parent application or the prosecution history thereof and advises the USPTO that the claims in this application may be broader than any claim in the parent application.

### FIELD OF THE INVENTION

The present invention relates to disambiguating a keyword. Specifically, the keyword is disambiguated by categorizing objects to which the keyword potentially refers.

### BACKGROUND

There are a growing number of online service providers, such as Web sites that provide rich media content and Web sites that provide social networking services. Online service providers do their best to provide content-specific advertisements. Currently, online service providers base advertising content on keywords from a number of locations. Content is provided based on keywords found in e-mails, blogs, and search queries. These keywords trigger various advertisements that are statistically likely to be associated with the keywords.

For example, if a user submits a query of “pizza” to a search engine, then the search engine may provide information about a wide variety of pizza delivery services. Similarly, a search for personals could cause the user to be directed to the Web site for Yahoo!® Personals by Yahoo! Inc., a well-known online service provider.

A problem arises when the online service provider finds a keyword that is associated with more than one likely meaning. For example, if a user types into her blog, “Let's eat popcorn during Orange County,” then the online service provider cannot make a proper determination of whether to send the user information about Orange County, Calif., or Orange County, the movie. If users that search for “Orange County” typically navigate to a specific Web page about Orange County, Calif., then an online service provider sending popular results for the keyword might send the specific Web page about the county to the user. Alternately, Web sites about buying popcorn in Orange County could be shown to the user.

Unfortunately for the user, the intended meaning was directed to Orange County, the movie, not Orange County, Calif. Most human beings reading the sentence would know that “Orange County” in the sentence refers to the movie entitled “Orange County,” not to the county of Orange. If the online service provider only has one chance to advertise the movie “Orange County” to the user, then the online service provider will miss the chance by sending the user information about Orange County, Calif. Thus, the online service provider would need to compute that the user's intent was to watch the movie Orange County, not to buy popcorn in Orange County.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram illustrating one system for computing the meaning of an ambiguous word.

FIG. 2 is a correlation matrix with example categories and correlation values, or counts.

FIG. 3 is a diagram illustrating one system for sending content to a user based on the meaning computed for an ambiguous word.

FIG. 4 is a block diagram that illustrates a computer system that can be used to resolve an entity into a real world object with a degree of confidence.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview of Disambiguation Method

Techniques are described for disambiguating a word or phrase. A first word and a second word are detected in a text. The first word is associated with a first object, and the second word is associated with a second object and a third object. Each of the objects is categorized into one or more categories, the first object into a first category, the second object into a second category, and the third object into a third category.

A correlation matrix is used to determine which of the second category or the third category is more associated with the first category. If the second category is more associated with the first category, then advertising content is sent to the client based on either the second object or the second category. If the third category is more associated with the first category, then advertising content is sent to the client based on either the third object or the third category.

### Generating a List of Keywords

There are numerous techniques that can be used to detect keywords in text. A first technique involves detecting the words that are capitalized in the text. The capitalized words are deemed to be keywords. A second technique involves detecting the words that appear in a dictionary or word list. The second technique is advantageous because the word list may be customized. In one embodiment, the word list is a list of unambiguous keywords, where each keyword is mapped to an object identifier that identifies a real world object.

Each entry, or keyword, in the list of entities is generated from one or more of a number of sources. Click logs from a search engine show queries that users have sent, search engine results for the queries, and to which pages users navigated. For example, a users who searched for “The Dark Knight” navigated to the Wikipedia® page identified as “The_Dark_Knight_(film)” 30% of the time, to the Internet Movie Database® (“IMDB®”) page identified as “tt0468569” (the movie, “The Dark Knight”) 50% of the time, and to other sites 20% of the time. Because the Wikipedia® page identified as “The_Dark_Knight_(film)” identifies the IMDB® page “tt0468569” in the “External links” section, clicks to both the IMDB® “tt0468569” page and the Wikipedia® “The_Dark_Knight_(film)” page can be attributed to the same object. For simplicity, that object can be identified using the Wikipedia ID “The_Dark_Knight_(film).” Accordingly, the click logs would show an 80% degree of confidence that a user typing “The Dark Knight” refers to the object identified as “The_Dark_Knight_(film).” If the degree of confidence passes a threshold, then the keyword, “The Dark Knight” can be stored in a list of unambiguous keywords and optionally mapped to the object ID “The_Dark_Knight_(film).”

Keywords are also generated from link graphs. Search engines use link graphs to rank pages. Pages that are most frequently linked to by other pages receive higher ranks. In the Dark Knight example, links with the anchor text, “The Dark Knight,” link to the IMDB® page identified as “tt0468569” 40% of the time, to the Rotten Tomatoes® page identified as “the_dark_knight” 30% of the time, to the Wikipedia® page identified as “The_Dark_Knight_(film)” 20% of the time, and to other pages 10% of the time. As discussed, the IMDB® page identified as “tt0468569” is associated with the Wikipedia® page identified as “The_Dark_Knight_(film)” via the “External links” section. Similarly, the Rotten Tomatoes® page identified as “the_dark_knight” is associated with the Wikipedia® page identified as “The_Dark_Knight_(film).” Accordingly, Web sites linked to information about the same Dark Knight movie 90% of the time, indicating a 90% degree of confidence that a Web site linking to “The Dark Knight” referred to the object identified as “The_Dark_Knight_(film).” In the example, the keyword, “The Dark Knight,” is optionally mapped to object ID “The_Dark_Knight_(film)” in the list of keywords.

Redirect lists are managed by online service providers in order to direct a user to a target page from another page. Redirect lists can also be used to expand the list of keywords. For example, if the user navigates to the Wikipedia® page identified as “Dark_Knight_(film)” instead of “The_Dark_Knight_(film),” then the user is redirected by Wikipedia® to “The_Dark_Knight_(film)” based in part on the editorial management of a redirect list. Similarly, if the user navigates to “The_Dark_Knight_(movie),” the user is also directed to “The_Dark_Knight_(film).” Underscores and parenthesis can be removed from the Wikipedia IDs when adding to the list of entities. For example, “Dark Knight film,” “The Dark Knight movie,” and “The Dark Knight film” can be added as keywords that all refer to “The_Dark_Knight_(film).”

A disambiguation list can also be used to generate entities for the list of keywords. Disambiguation lists are lists of pages that are suggested to a user when the user submits a query. For example, if the user submits “Dark Knight” to Wikipedia®, then the user is provided with a disambiguation list that includes “The_Dark_Knight_(film)” at the top of the list based in part on the editorial management of a disambiguation list. Accordingly, the disambiguation list indicates that the keyword “Dark Knight” would map to “The_Dark_Knight_(film).”

An object list can be used to generate entities for the list of keywords. For example, a Wikipedia object list includes “The_Dark_Knight_(film).” Unique substrings of the object identifier, such as “The Dark Knight,” “Dark Knight film,” and “The Dark Knight film,” can be used to generate keywords for the keyword list. Non-unique substrings, such as “Knight,” would not be mapped to the object identified as “The_Dark_Knight_(film).” Instead, the non-unique substring “Knight” would be mapped to the object identified as “Knight,” which better matches the substring.

### Detecting Keywords in a Text

Once the list of entities is generated, detecting entities in a text is simple. The text is compared with the list of entities. If a particular entity text matches the text or a substring of the text, then the particular entity text is identified as an entity. A query is a text inputted by a user that may contain one or more entity texts. Each entity text is detected from the list of entities.

Some entity texts may be overlapping. For example, the entity texts “Knight” and “The Dark Knight” are overlapping. There are many different techniques that could be used to resolve overlapping entity texts. For example, either the entity that starts first or the longest entity could be used, discarding the other overlapping entities. In one embodiment, the most popular entity, which is determined by the click logs, link graphs, redirect lists, disambiguation lists, and object lists, is used, discarding the other overlapping entities. For simplicity, though, the entity text to be used can simply be the longest entity text, giving preference to the leftmost entity in case of a tie in entity length.

Keywords, or entity texts, found in the dictionary, or list of entities, are mapped to at least one object and at least one category. In one embodiment, the dictionary holds only unambiguous keywords, i.e., keywords that are mapped to only one object. The dictionary of unambiguous keywords is used if the correlation matrix is to only include correlation values of categories from unambiguously identified objects.

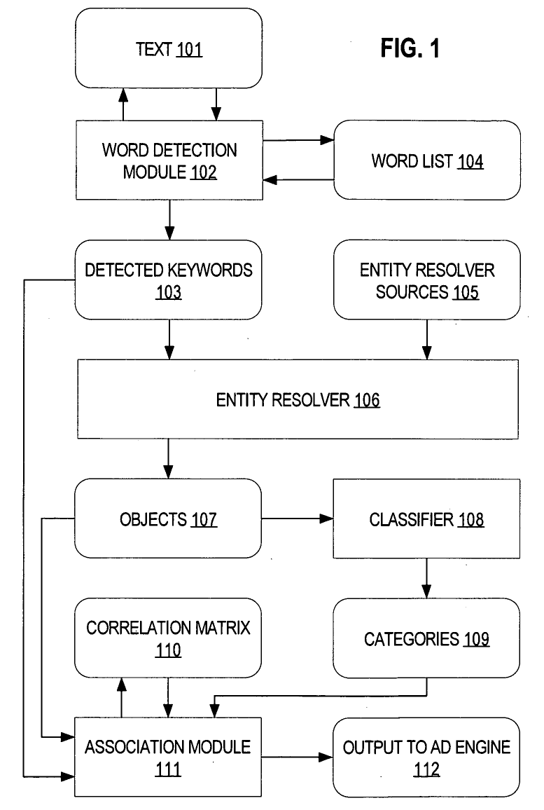

FIG. 1 is a detailed diagram illustrating one system for resolving an entity into a real world object with a degree of confidence. Word detection module 102 finds an entity text, string, or keyword 103 in text 101. Word detection module 102 detects keyword 103 in text 101 by searching for portions of text 101 in word list 104. Alternatively, word detection module 102 detects keyword 103 in text 101 by searching for members of word list 104 in text 101. In another embodiment, word detection module 102 is provided with keyword 103 and text 101 associated with keyword 103.

Text 101 is a document, blog, email, note, Web page, or any other collection of characters. Word list 104 is any list of words, such as an online dictionary or a list of words stored in memory. If keyword 103 is in word list 104, then keyword 103 is recognized as a detected keyword.

### Mapping Keywords to Objects

As discussed above in “GENERATING A LIST OF KEYWORDS,” and as described in “System For Resolving Entities In Text Into Real World Objects Using Context,” U.S. application Ser. No. 12/251,146, filed Oct. 14, 2008, the entire contents of which have been incorporated by reference as if fully set forth herein, the keyword is then mapped to an object identifier using one or more of a variety of sources. The object identifier identifies a real world object to which various keywords and information may refer. For example, “The_Dark_Knight_(film)” identifies a Wikipedia® page that presents information about the film, The Dark Knight. The object identifier, “The_Dark_Knight_(film),” is also associated with information from IMDB® ID “tt0468569” and Rotten Tomatoes® ID “the_dark_knight,” as described above in “GENERATING A LIST OF ENTITIES.” Various keywords, such as “Dark Knight,” “The Dark Knight,” “Dark Knight movie,” and “Dark Knight film,” all refer to the object ID “The_Dark_Knight_(film).”

For each detected keyword 103, word detection module 102 passes detected keyword 103 to entity resolver 106. Entity resolver 106 resolves keyword 103 into an object 107 identified by an object identifier. To resolve keyword 103 into object 107, entity resolver 106 uses any source of a group of entity resolver sources 105 including: click logs, link graphs, redirect lists, disambiguation lists, and object lists. Alternately, the entity texts in word list 104 are mapped to object IDs upon creation of word list 104 based in part on entity resolver sources 105. Each source from the group of entity resolver sources 105 associates keyword 103 to object 107 with an object degree of confidence. If entity resolver 106 uses more than one source from the group of entity resolver sources 105, then entity resolver 106 can weigh each source and combine the objects 107 and object degrees of confidence into a combined list of objects 107 and object degrees of confidence. Alternately, entity resolver 106 uses one source of the group of entity resolver sources 105 to determine the object 107 and degree of confidence.

As used herein, “object” refers to any real world subject matter. An object identifier is used on the computer to identify an object and associate the object with keywords and categories. Therefore, when an object is associated with a keyword, an association is stored between the object identifier and the keyword. For example, the object Orange County, Calif., is a county that exists in California. The county itself, including the land, water, and trees, is meaningless to a computer, though. The object identifier, “Orange_County,_California,” is used to identify a collection of content about the object. In the example, “Orange_County,_California” identifies a Wikipedia® page with information (content) about the object Orange County, Calif. Because the object itself is meaningless to a computer, the terms “object” and “object identifier” may be used interchangeably when discussing the disclosed method.

In the Orange County example, the keyword “Orange County” is associated with objects based upon a statistical analysis of the keyword's ordinary use. The statistical analysis is based on search engine click logs, link graphs using anchor text, editorially managed redirect lists, and/or a list of objects. For example, “Orange County” can be associated with the objects identified as “Orange_County,_California” and “Orange_County_(film).” In one embodiment, object names are the names of Wikipedia® pages. Each Wikipedia® page has a name that corresponds to a unique Wikipedia® entry. In the Orange County example, the Wikipedia® page name “Orange_County,_California” is associated with a Wikipedia® page about Orange County, Calif. Wikipedia® is a registered trademark of the Wikimedia Foundation, Inc.

In one embodiment, the objects identified as “Orange_County,_California” and “Orange_County_(film),” are predicted with some degree of confidence based on a statistical analysis from click logs for “Orange County,” link graphs using anchor text “Orange County,” redirect lists for “Orange County,” disambiguation lists for “Orange County,” and lists of objects named “*Orange*County*,” where * represents a wildcard placeholder. Example degrees of confidence are 0.85 for the object identified as “Orange_County,_California,” and 0.15 for the object identified as “Orange_County_(film),” indicating that the online service provider can be more confident that the keyword represents the object identified as “Orange_County,_California” than the object identified as “Orange_County_(film).”

### Categorizing Objects

Referring again to FIG. 1, the Yet Another Great Ontology (YAGO) system can be used as classifier 108 to map an object identifier 107 to an entity category 109. The YAGO ontology is accessible through a URL. Alternately, the YAGO ontology can be downloaded for more efficient and reliable access. The YAGO ontology categorizes Wikipedia page names, or object identifiers. A more detailed description of the YAGO ontology is found in Suchanek, F. M., Kasneci, G. & Weikum, G., “YAGO: A Core of Semantic Knowledge—Unifying WordNet and Wikipedia®,” The 16th International World Wide Web Conference, Semantic Web: Ontologies Published by the Max Planck Institut Informatik, Saarbrucken, Germany, Europe (May 2007), which has been incorporated by reference in its entirety.

The YAGO ontology utilizes Wikipedia® category pages, which list Wikipedia® object identifiers that belong to the category pages. For example, “The_Dark_Knight” can be identified as a film because it belongs to the “2008_in_film” category page. In YAGO, the Wikipedia® categories, like other object identifiers, are stored as entities. A relationship is created between non-category Wikipedia® entities (“individuals”) and category Wikipedia® entities (“classes”). For example, YAGO stores an entity, relation, entity triple (“fact”) as follows: “The_Dark_Knight TYPE film.” Wikipedia® categories alone do not yet provide a sufficient basis for a well-structured ontology because the Wikipedia® categories are organized based on themes, not based on logical relationships. See Suchanek, et al.

Unlike Wikipedia®, WordNet® provides an accurate and logically structured hierarchy of concepts (“synsets”). A synset is a set of words with the same meaning. WordNet® provides a hierarchical structure among synsets where some synsets are sub-concepts of other synsets. WordNet® is accurate because it is carefully developed and edited by human beings for the purpose of developing a hierarchy of concepts for the English language. Wikipedia®, on the other hand, is developed through a wide variety of humans with various underlying goals. See Suchanek, et al.

To take advantage of the hierarchical structure in WordNet®, the YAGO ontology maps Wikipedia® categories to YAGO classes. Various techniques for mapping Wikipedia® categories to YAGO classes are described in Suchanek, et al. In one embodiment, the YAGO ontology exploits the Wikipedia® category names. Wikipedia® category names are broken down into a pre-modifier, a head, and a post-modifier. For example, “2008 in film” would be broken down into “2008 in” (pre-modifier) and “film” (head). If WordNet® contains a synset for the pre-modifier and head, then the synset is related to the category. If not, a synset related to the head is related to the category. If there is no synset that matches the pre-modifier and head or the head alone, then the Wikipedia® category is not related to a WordNet® synset. In the example, the head of the category matches the synset “film” as follows: “2008 in film TYPE film.” By classifying “2008 in film” as “film,” YAGO can determine that “The_Dark_Knight_(2008)” is a “film.”

In one embodiment, an object ID is mapped to more than one category. For example, “The_Dark_Knight_(2008)” may be categorized under “film” and “superhero.” Optionally, a separate annotated query may be generated for each category. In another embodiment, the entity categories can be combined into a entity category placeholder that refers to both entities. The placeholder may, for example, be of the form: <<film><superhero>>. In yet another embodiment, the least common or worst fitting category is ignored. If, for example, the classifier is 70% sure that “The_Dark_Knight_(2008)” fits under “superhero” and 80% sure that “The_Dark_Knight_(2008)” fits under “film,” then “film” is used as the category.

Referring back to FIG. 1, classifier 108, which may be a YAGO classifier or any other system that classifies entities, maps object ID 107 to entity category 109. Entity category 109, detected entity 103, and query 101 are sent to annotated query generation module 110.

In the “Orange County” example, the objects identified “Orange_County,_California” and “Orange_County_(film),” are classified into categories. In one embodiment, Wikipedia® is used to find categories for the objects based on categories manually created with Wikipedia® pages. Wikipedia® makes categories available in a SQL (Structured Query Language) database. Due to the lack of conformity in Wikipedia® category names, a more reliable source of object categories is preferred.

Using YAGO, the objects identified as “Orange_County,_California” and “Orange_County_(film)” are classified. An input of “Orange_County,_California,” if identified as a county by YAGO, would cause the categories “County” and/or “Place” to be returned. Similarly, an input of “Orange_County_(film),” if identified as a motion picture film by YAGO, would cause the categories “Film” and/or “MotionPictureFilm” to be returned. The categories associated with the objects are called the object categories.

### Unambiguous Keywords

One way for an online service provider to provide content-specific advertisements to a user involves selecting advertisements based on keywords, or strings of characters, found in the user's emails, blogs, or notes. This method can be called the keyword technique. Some keywords refer to only a single object, but some keywords can refer to multiple objects. Keywords that refer to only one object are called unambiguous keywords because the keyword technique alone can reliably identify to what the keyword refers. Based on an unambiguous keyword, the online service provider can choose content to send to the user. For example, if the user types, “I like to eat pizza,” in an email, then the online service provider could send the user content (e.g., advertisements) associated with the keyword, “pizza.” The content can be any advertisement that falls under a keyword category, “pizza.” The content may be in the form of an advertisement for pizza delivery services, or information about making a pizza at home. The keyword technique alone cannot reliably identify to what object the user is referring when the keyword is ambiguous.

### Ambiguities From Keywords

Ambiguous keywords have more than one potential meaning. One example of an ambiguous keyword is “Amazon.” An online service provider using the keyword technique cannot disambiguate keywords like “Amazon” because there are many possible meanings for “Amazon.” Disambiguation is the process of resolving an ambiguity of meaning. One way to disambiguate “Amazon” is to ask the user to which Amazon he or she was referring. Obviously, online service providers do not have enough time or money to poll each user before each advertisement. Also, users are not interested enough in advertisements to participate in such a poll.

Another way to resolve ambiguous keywords involves determining the intended meaning of the keyword based on the context of the keyword. The context of the keyword is determined based on the portion of text surrounding the keyword. In the example involving the keyword, “Amazon,” a first text containing Amazon could read, “The Amazon is a tropical rainforest.” Based on the context, the sentence structure, or the distance between words, a keyword “tropical rainforests” can be associated with the keyword “Amazon.” In the example, a connecting word, “is,” appears in the same sentence, or larger text, with the two words, “Amazon” and “tropical rainforest.” Further, the connecting word, “is,” appears between the two words. Two words connected by the connecting word, “is,” are usually similar.

The keyword technique is much less effective as the sentence structure becomes more complex and the keywords become more ambiguous. For example, a second text containing Amazon could read, “Illegal logging has a negative impact on the Amazon.” The keyword “Amazon” is still ambiguous, but the context does not provide much assistance for the keyword technique. Without knowing more about Amazon, an online service provider using the keyword technique could rely on sites to which users most frequently navigate when they search for “Amazon.” Here, the user may be directed to Amazon.com, or even to a book about illegal logging on Amazon.com. When reading the sentence, “Illegal logging has a negative impact on the Amazon,” most human readers would know that “Amazon” in the sentence refers to the Amazon rainforest, not to Amazon.com. Due to the complexity of language, the context of a keyword can be difficult for a machine to determine.

Certain keywords may be ambiguous even with descriptive, unambiguous context. For example, “Romeo and Juliet is a nice movie,” is ambiguous even though the surrounding text is descriptive. The keyword, “Romeo and Juliet” in the sentence can refer to tens or possibly hundreds of different movies. A user who typed “Romeo and Juliet is a nice movie” may be directed to a page about any one of the Romeo and Juliet movies, or possibly even to a page about a book or play entitled “Romeo and Juliet.”

### Exemplary System for Disambiguating a Keyword

A more reliable method for resolving ambiguous keywords from a text involves mapping a first keyword to a first list of objects to which the first keyword potentially refers and a second keyword to a second list of objects to which the second keyword potentially refers. Each object of the lists of objects is mapped to a category or categories. Correlation values between the categories of the first list of objects and categories of the second list of objects are retrieved from a correlation matrix. A highest correlation value is selected and indicates that a first category for a first object of the first list of objects most frequently co-occurs with a second category of a second object of the second list of objects.

In one embodiment, an association between the first keyword and the first object is stored. In another embodiment, an association between the second keyword and the second object is stored. Advertising content for the text is then selected based on any of the first object, the first category, the second object, or the second category.

### Examples of Mapping Unambiguous Keyword to Category

In the example using the text, “Illegal logging has a negative impact on the Amazon,” the keyword “illegal logging” is not ambiguous, but the keyword “Amazon” is ambiguous. The keyword “illegal logging” refers to the object identified by the page entitled, “Illegal_logging,” which provides information about illegal logging. The object identified as “Illegal_logging” maps to the categories, “EnvironmentalThreats” and “Crimes.”

In the example, “Let's eat popcorn during Orange County,” the keyword “popcorn” is not ambiguous, but the keyword “Orange County” is ambiguous. The keyword “popcorn” refers to the object identified as, “Popcorn,” which maps to a “SnackFoods” category.

### Examples of Mapping Ambiguous Keyword to Category

The keyword “Amazon” may be associated with either the object identified as “Amazon.com,” which refers to an informational page about Amazon.com, or the object identified as “Amazon_Rainforest,” which refers to an informational page about the Amazon rainforest. The object identified as “Amazon.com” maps to the categories, “OnlineRetailCompaniesOfTheUnitedStates” and “CompaniesListedOnNASDAQ.” The object identified as “Amazon_Rainforest” maps to the categories “Rainforests” and “RegionsOfSouthAmerica.” Thus, the four categories may fall under “Amazon” via the objects identified as “Amazon.com” and “Amazon_Rainforest.”

The keyword “Orange County” in the Orange County example may be associated with either the object identified as “Orange_County_California,” which refers to a county in California, or the object identified as “Orange_County_(film),” which refers to a film from 2002. The object identified as “Orange_County_California” maps to “County” and “Place.” The object identified as “Orange_County_(film)” maps to “Film” and “MotionPictureFilm.”

### Examples of Using the Correlation Matrix

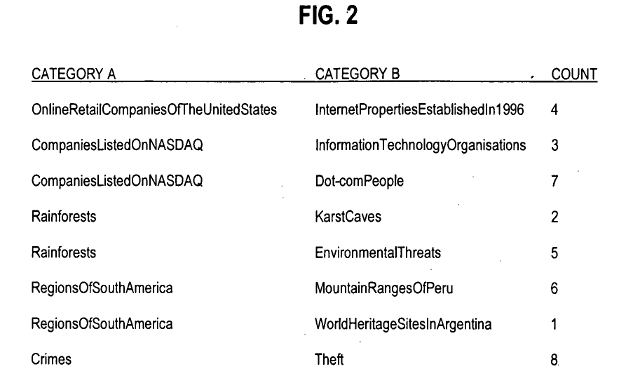

A correlation matrix like the one shown in FIG. 2 has information about which of the four categories under the keyword “Amazon” are related to which of the two categories under “illegal logging.” Before analyzing the sentence, “illegal logging has a negative impact on the Amazon,” the online service provider may have used training data such as articles, Web sites, and other documents online to determine that the “Rainforests” category is related to the “EnvironmentalThreats” category. Based on the determination, the online service provider would have stored information indicating that “Rainforests” is related to “EnvironmentalThreats.” The stored information may be used at another time to compute that another object in the “Rainforests” category is likely related to another object in the “EnvironmentalThreats” category.

For example, to create an entry in the correlation matrix, the online service provider may use training data that includes an article saying: “habitat destruction often impacts tropical rainforests.” In the example, “habitat destruction” refers to the object identified as “Habitat_destruction,” which is the name of an informational page about habitat destruction, and tropical rainforests would refer to the object identified as “Tropical rainforest,” which is the name of an informational page about tropical rainforests. The object identified as “Habitat_destruction” is categorized into the “EnvironmentalThreats” category, and the object identified as “Tropical_rainforest” is categorized into the “Rainforests” category. The correlation matrix stores information to reflect that “Rainforests” and “EnvironmentalThreats” have occurred together.

When using the correlation matrix later to determine which of the four categories under “Amazon” is related to which of the two categories under “illegal logging,” the online service provider would determine that “Rainforests” and “EnvironmentalThreats” have previously co-occurred as indicated by the correlation matrix. FIG. 2 shows that keywords appearing together in the training data mapped to the two categories a total of fives times for this example.

The online service provider in the “Amazon” example would be able to disambiguate “Amazon” in the text, “illegal logging has a negative impact on the Amazon,” by determining that “Amazon” refers to the object, “Amazon_Rainforest,” which falls under the category “Rainforests.” The online service provider is able to perform the disambiguation based partially upon the count of five times that keywords mapping to objects of the types “Rainforests” and “EnvironmentalThreats” previously occurred together. Accordingly, the keyword “Amazon” more likely refers to an object under the “Rainforests” category when the keyword appears with another keyword that refers to an object under the “EnvironmentalThreats” category.

In the Orange County example, a diverse set of training data would allow the online service provider to update the correlation matrix so that a high correlation value is stored between the categories “Film” and “MotionPictureFilm” and the category “SnackFoods.” Therefore, the category “SnackFoods” will be much more correlated with “MotionPictureFilm” and “Film” than “County” or “Place.” Accordingly, the online service provider would compute that “Orange County” refers to the object identified as “Orange_County_(film)” in the example.

In fact, it is a tradition to eat popcorn while watching movies. The online service provider can expect a lot of data linking “SnackFoods” to “MotionPictureFilm.” Other snacks, such as “Twizzlers” and “Milk_Duds,” might be mapped to the “SnackFoods” category along with “Popcorn.” A text, “Let's eat Twizzlers during Orange County,” or “Let's eat milk duds during Orange County,” would produce similar results using the disclosed method because the “SnackFoods” category is correlated to the “Film” category. Notably, a detection of the keyword “Twizzlers” might trigger the disclosed method to select the object identified by “Orange_County_(film)” for the keyword “Orange County” even if “Twizzlers” never appeared with “Orange County” in the training data.

### Building Correlation Matrix

FIG. 2 shows counts for category-to-category relationships in the correlation matrix. The counts are incremented when new category-to-category relationships are found in training data. Specifically, FIG. 2 shows that the category OnlineRetailCompaniesOfTheUnitedStates was associated with the category InternetPropertiesEstablishedIn1996 a total of four times in the training dataset; CompaniesListedOnNASDAQ was associated with InformationTechnologyOrganisations three times and Dot-comPeople seven times; Rainforests was associated with KarstCaves two times and EnvironmentalThreats five times; RegionsOfSouthAmerica was associated with MountainRangesOfPeru six times and WorldHeritageSitesInArgentina one time; and Crimes was associated with Theft eight times.

A correlation matrix keeps a count of how frequently keywords representing objects of certain categories are detected in a specified relationship. The specified relationship is a textual proximity of the first keyword and the second keyword. The specified relationship may be satisfied when the first keyword appears within a specified number of words, perhaps twenty, from the second keyword. Alternately, the specified relationship may be satisfied when the first keyword and the second keyword appear in the same sentence, paragraph, or document. The online service provider crawls through potentially terabytes of training data to find keywords that represent objects. The objects are mapped to certain categories, and the correlation matrix stores the frequency by which keywords representing objects of a pair of categories are detected together.

As used herein, category A is said to “occur” when a keyword representing an object of category A is detected in a text from the training data. Category A is said to “co-occur” with category B when a first keyword representing a first object of category A is detected in a specified relationship with a second keyword representing a second object of category B. In one embodiment, if category A co-occurs 50 times with category B, the correlation matrix stores 50 for the A, B category pair.

In another embodiment, the correlation matrix stores information indicating the relative frequency by which categories co-occur. For example, suppose category X occurs 50 times total, category Y occurs 75 times total, and category Y co-occurs with X 25 times. In the example, the relative frequency is provided as Count(X and Y together)/(Count(X)*Count(Y)), or 0.00667. In the correlation matrix, a value of 0.00667 could be stored for the (X, Y) category pair. Alternately, the correlation matrix could store the total number of times X and Y each occur separately and the total number of times X and Y occur together. The relative frequency is then computed by using these values.

In one embodiment, a secondary correlation matrix is generated based on the correlation matrix. The secondary correlation matrix is created by storing values from the correlation matrix that are above a threshold. For example, if a value of 0.00667 is stored for the (X, Y) category pair, and a value of 0.00333 is stored for an (X, Z) category pair, then a threshold of 0.005 would cause only the correlation value between X and Y to be stored in the secondary correlation matrix, not the correlation value between X and Z.

Alternately, a threshold can be created for the total number of times that values occur. In the example above, a correlation value for X and Y of 0.00667 passes a threshold of 0.005 for the relative number of times X and Y occur together. However, X and Y would not pass a threshold of 30 for the total number of times X and Y occur together. Therefore, a threshold on the total number of times that the values occur would cause X and Y to be ignored when the secondary correlation matrix is created.

### Training Data Using Unambiguous Keywords

The training data used to create the correlation matrix can include any number of reliable electronic sources. Accordingly, the correlation matrix is scalable over the entire Web of electronic news sources, Web pages, blogs, documents, and other electronic data sources. A “text” as defined herein is a portion of text within a document, a whole document, or a collection of documents, keywords, or characters, where a first keyword and a second keyword are detected in a specified relationship.

Keywords are detected in the text based on a dictionary of keywords. The dictionary of keywords can be built from click logs, link graphs, redirect lists, object lists, and disambiguation lists. Keywords found in the dictionary are mapped to at least one object and at least one category. In one embodiment, one dictionary holds only unambiguous keywords, i.e., keywords that can be mapped to only one object. The dictionary of unambiguous keywords can be used if the correlation matrix is to be built only on unambiguous keywords. Using only unambiguous keywords to create the correlation matrix provides a higher level of accuracy for the correlation values of associated categories because the results are generated based on unambiguous keyword-object mappings.

In order to map the keywords to objects, the entity resolver uses inputs from click logs, link graphs, redirect lists, object lists, and disambiguation lists, to resolve the keyword into at least one object, identified by a Wikipedia® entry in one embodiment. The process of resolving keywords into objects is described in detail in application Ser. No. 12/251,146, filed Oct. 14, 2008, the entire contents of which have been incorporated by reference as if fully set forth herein. Although the examples illustrated herein utilize Wikipedia® as a source of object content and object identifiers, any other informational resource could be used to pair object identifiers with object content. For example, a different encyclopedia database or an online dictionary could be used.

For unambiguous keywords detected together, like “habitat destruction” and “tropical rainforest” in the “Amazon” example, categories for the keywords are associated by incrementing the count, or the correlation value, in the correlation matrix. For example, the count associating “Rainforests” with “EnvironmentalThreats” is incremented from 4 to 5 when the keyword “tropical rainforest” is detected in a specified relationship with the keyword “habitat destruction.”

### Training Data Using Ambiguous Keywords

In another embodiment, the dictionary contains both ambiguous and unambiguous keywords. When a keyword maps to more than one object, a confidence level can be associated with each object. For example, a confidence level of 0.7 represents a 70% certainty that the “Amazon” keyword refers to the object identified as “Amazon.com.” A confidence level of 0.3 represents a 30% certainty that “Amazon” refers to the object identified as “Amazon_Rainforest.” The process of determining a confidence level for a keyword-to-object mapping is described in detail in application Ser. No. 12/251,146, filed Oct. 14, 2008, the entire contents of which have been incorporated by reference as if fully set forth herein.

If “Amazon” is detected with an unambiguous keyword in the training data, then the correlation value between the categories for “Amazon.com” and the categories for the unambiguously identified object are incremented by 0.7. Similarly, the correlation value between the categories for “Amazon_Rainforest” and the categories for the unambiguously identified object are incremented by 0.3.

In another embodiment, both detected keywords in the training data could be ambiguous. For example, if the other keyword is “mouse,” then the “mouse” keyword might have a confidence level of 0.6 for Mouse and 0.4 for Mouse_(computing). In the training data, a value of 0.7 times 0.6, or 0.42, could be stored for an association between categories for “Amazon.com” and “Mouse;” a value of 0.3 times 0.6, or 0.18, could be stored for an association between categories for “Amazon_Rainforest” and “Mouse;” a value of 0.7 times 0.4, or 0.28, could be stored for an association between categories for “Amazon.com” and “Mouse_(computing);” and a value of 0.3 times 0.4, or 0.12, could be stored for an association between categories for “Amazon_Rainforest” and “Mouse_(computing).”

### Using the Correlation Matrix

Correlation matrix 110 stores correlation values between categories 109. Association module 111 reads the correlation values between categories 109 and determines a first category of categories 109 for a first object from a first keyword which is most frequently co-occurring with a second category of categories 109 for a second object from a second keyword.

When association module 111 determines the first category and the second category that most frequently co-occur, association module 111 then sends output 112 to an ad engine. Output 112 can include any of: the first category, the second category, other categories associated with the first object or the second object, the first object, the second object, other objects in the first category or the second category, the first keyword, the second keyword, and other keywords associated with the objects or categories. The first object represents the predicted meaning of the first keyword by association module 111. The second object represents the predicted meaning of the second keyword by association module 111.

By sending output 112 to the ad engine, association module 111 stores information that indicates that the first keyword is associated with the first object and the second keyword is associated with the second object. In one embodiment, the information is stored in a packet to be sent to the ad engine. In another embodiment, the information is stored on a hard disk shared with the ad engine. Additionally, the information stored may include text 101 or a portion of text 101 from which the keywords 103 were detected.

### Sending Object-Specific or Category-Specific Ads

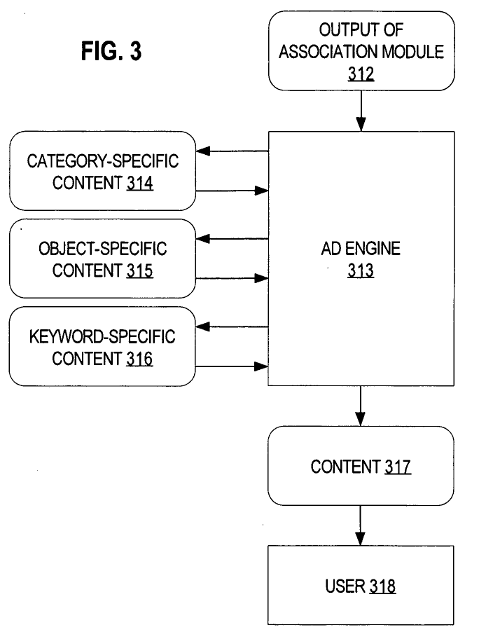

FIG. 3 is a diagram showing one way that an ad engine 313 determines content 317 to send to a user 318. Ad engine 313 receives output 312 of the association module, which may be one or more categories, objects, and/or keywords to use for determining content 317. Ad engine 313 then determines which content 317 to send to user 318 based on the following: content organized by category, or category-specific content 314; content organized by object, or object-specific content 315; and/or content organized by keyword, or keyword-specific content 316. Content 317 selected from the category-specific content 314, object specific content 315, and/or keyword-specific content 316 is sent to user 318 to be displayed in response to detecting text 101 containing keywords 103 typed by the user.

### Testing Data

Object content can be used to test the accuracy of the disambiguation method described herein. Object identifiers, or Wikipedia® IDs, are associated with Wikipedia® entries. The Wikipedia® entries have user-generated content with links to other Wikipedia® entries. If the links to other Wikipedia® entries are eliminated from the text, the disambiguation method can be run on the content to determine with what accuracy the online service provider can disambiguate keywords in the text related to objects identified by the Wikipedia® entries.

For example, the content of the “Amazon_Rainforest” Wikipedia® page contains the following sentence: “In the river, electric eels can produce an electric shock that can stun or kill, while Piranha are known to bite and injure humans.” On the “Amazon_Rainforest” Wikipedia® page, the sentence appears with links for “electric eels” and “Piranha.” The text “electric eels” links to the Wikipedia® entry “Electric_eel” at the URL “http://en.Wikipedia.org/wiki/Electric_eel.” The text “Piranha” links to the Wikipedia® entry “Piranha” at the URL “http://en.Wikipedia.org/wiki/Piranha.” The links to “Electric_eel” and “Piranha” are removed before testing the accuracy of the disambiguation method.

After removing these links, the disambiguation method detects the keyword “electric eels” if “electric eels” is a term in the online service provider's word list. Similarly, the disambiguation method detects the keyword “Piranha” if “Piranha” is a term in the word list. Using the entity resolver, the keywords are mapped to objects. Given the unambiguous nature of these keywords, the entity resolver has a high probability of mapping “electric eels” to the object identified by “Electric_eel” and “Piranha” to the object identified by “Piranha.” The links may then be reconstructed based on the object selected for the detected keyword. For example, the text “electric eels” may be linked to the URL “http://en.Wikipedia.org/wiki/Electric_eel.”

The page with reconstructed links may then be compared to the content of the object “Amazon_Rainforest.” If the disambiguation method created links that agree with the content of the Wikipedia® page, then the disambiguation method was correctly reconstructed. If the disambiguation method correctly reconstructs a high percentage of links, then the disambiguation method is said to be accurate. If the disambiguation method correctly reconstructs a low percentage of links, then the disambiguation method is said to be inaccurate. If the disambiguation method created links that disagree with the content of the Wikipedia® page, then the results can be analyzed to determine what training data caused the links to be incorrectly associated. The threshold level, the sources of training data, and the specified relationship can then be modified so that the disambiguation method runs more accurately in subsequent tests.

### Hardware Overview

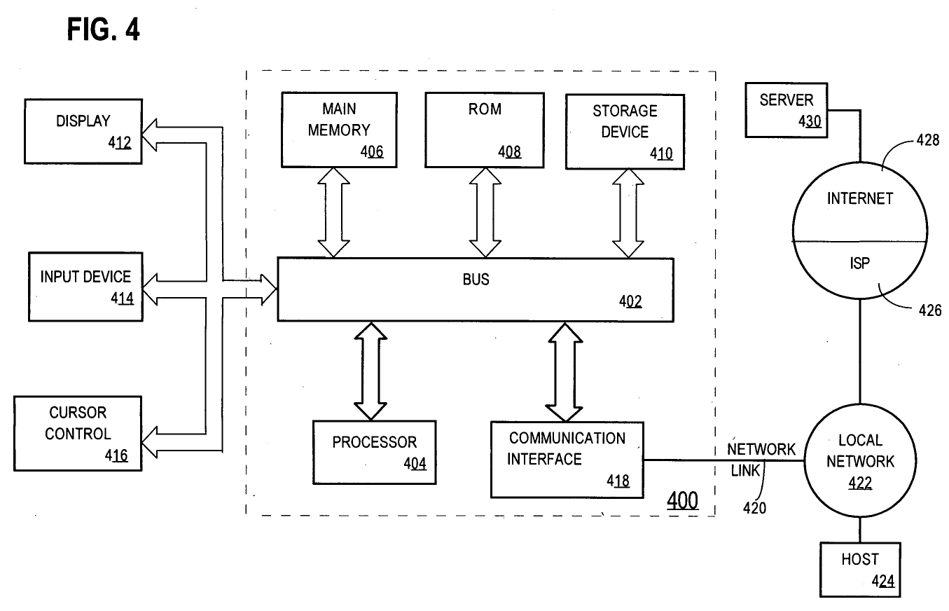

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to storage media and transmission media. Storage media includes both non-volatile media and volatile media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
determining a first object that represents a first word;
determining a second object and a third object for a second word;
determining a first category for the first object, a second category for the second object, and a third category for the third object;
determining that the first category is associated with the second category; and
based at least in part on the first category being associated with the second category, storing, on a volatile or non-volatile computer-readable storage medium, information that indicates that the second word is represented by the second object.

2. The computer-implemented method of claim 1, further comprising detecting the first word and the second word in a specified relationship.

3. The computer-implemented method of claim 2, wherein the specified relationship is satisfied when the first word and the second word are in a textual proximity.

4. The computer-implemented method of claim 3, wherein the textual proximity is selected from the group consisting of:
a specified number of words;
a single sentence;
a single paragraph; and
a single document.

5. The computer-implemented method of claim 1, wherein the association of the first category and the second category is based at least in part on a frequency with which a plurality of words represented by objects of the second category are in a specified relationship with a plurality of words represented by objects of the first category.

6. The computer-implemented method of claim 5, wherein the association of the first category and the second category is also based at least in part on a threshold of the frequency.

7. The computer-implemented method of claim 5, wherein the frequency is relative to a total frequency with which a plurality of words represented objects of a plurality of categories are in a specified relationship with a plurality of words represented by objects of the first category.

8. The computer-implemented method of claim 5, wherein the frequency is relative to another frequency with which a plurality of words represented by objects of the third category are in a specified relationship with a plurality of words represented by objects of the first category.

9. The computer-implemented method of claim 1, further comprising:
detecting a third word and a fourth word in a specified relationship;
determining a third object that represents the third word and a fourth object that represents the fourth word;
determining the first category for the third object and the second category for the fourth object;
storing, on a volatile or non-volatile computer-readable storage medium, information that indicates that the first category is associated with the second category.

10. The computer-implemented method of claim 1, further comprising testing the stored information by:
storing a content for the object, wherein the content contains a user-generated link from the second word to another object; and
determining whether the other object is the second object.

11. A computer-implemented method comprising:
detecting a first word and a second word in a specified relationship;
determining a first object that represents the first word and a second object that represents the second word;
determining a first category for the first object and a second category for the second object; and
storing, on a volatile or non-volatile computer-readable storage medium, information that indicates that the first category is associated with the second category.

12. The computer-implemented method of claim 11, wherein the specified relationship comprises a textual proximity of the first word and the second word.

13. The computer-implemented method of claim 12, wherein the textual proximity is selected from the group consisting of:
a specified number of words;
a single sentence;
a single paragraph; and
a single document.

14. The computer-implemented method of claim 1, wherein the storing of information comprises adding to a frequency with which a plurality of words represented by objects of the second category are in the specified relationship with a plurality of words represented by objects of the first category.

15. The computer-implemented method of claim 14, further comprising storing secondary information based at least in part on a threshold of the frequency.

16. The computer-implemented method of claim 15, wherein the secondary information is stored as a value in a list of category-to-category associations where only those associations that meet the threshold are stored in the list.

17. A computer-implemented method comprising:
determining that a first word is associated with a first meaning;
determining that a second word is associated with a second meaning;
determining that the first meaning belongs to a first category;
determining that the second meaning belongs to a second category;
determining that the first word is in a specified relationship with the second word;
in response to determining that the first word is in the specified relationship with the second word, storing first information that indicates that the first category is associated with the second category;
determining that a third word is associated with a third meaning;
determining that the third meaning is associated with the first category;
determining that the third word is in the specified relationship with a fourth word that is associated with a plurality of different meanings;
in response to determining that the third word is in the specified relationship with the fourth word, selecting, based at least in part on the first information, a particular meaning from the plurality of meanings; and
storing, on a volatile or non-volatile computer-readable storage medium, second information that indicates that the fourth word is associated with the particular meaning.

18. A volatile or non-volatile computer-readable storage medium storing one or more sequences of instructions which, when executed by one or more processors, cause the one or more processors to perform the steps recited in claim 1.

19. A volatile or non-volatile computer-readable storage medium storing one or more sequences of instructions which, when executed by one or more processors, cause the one or more processors to perform the steps recited in claim 2.

20. A volatile or non-volatile computer-readable storage medium storing one or more sequences of instructions which, when executed by one or more processors, cause the one or more processors to perform the steps recited in claim 3.

21. A volatile or non-volatile computer-readable storage medium storing one or more sequences of instructions which, when executed by one or more processors, cause the one or more processors to perform the steps recited in claim 4.

22. A volatile or non-volatile computer-readable storage medium storing one or more sequences of instructions which, when executed by one or more processors, cause the one or more processors to perform the steps recited in claim 5.

23. A volatile or non-volatile computer-readable storage medium storing one or more sequences of instructions which, when executed by one or more processors, cause the one or more processors to perform the steps recited in claim 6.

24. A volatile or non-volatile computer-readable storage medium storing one or more sequences of instructions which, when executed by one or more processors, cause the one or more processors to perform the steps recited in claim 7.

25. A volatile or non-volatile computer-readable storage medium storing one or more sequences of instructions which, when executed by one or more processors, cause the one or more processors to perform the steps recited in claim 8.

26. A volatile or non-volatile computer-readable storage medium storing one or more sequences of instructions which, when executed by one or more processors, cause the one or more processors to perform the steps recited in claim 9.

27. A volatile or non-volatile computer-readable storage medium storing one or more sequences of instructions which, when executed by one or more processors, cause the one or more processors to perform the steps recited in claim 10.

28. A volatile or non-volatile computer-readable storage medium storing one or more sequences of instructions which, when executed by one or more processors, cause the one or more processors to perform the steps recited in claim 11.

29. A volatile or non-volatile computer-readable storage medium storing one or more sequences of instructions which, when executed by one or more processors, cause the one or more processors to perform the steps recited in claim 12.

30. A volatile or non-volatile computer-readable storage medium storing one or more sequences of instructions which, when executed by one or more processors, cause the one or more processors to perform the steps recited in claim 13.

31. A volatile or non-volatile computer-readable storage medium storing one or more sequences of instructions which, when executed by one or more processors, cause the one or more processors to perform the steps recited in claim 14.

32. A volatile or non-volatile computer-readable storage medium storing one or more sequences of instructions which, when executed by one or more processors, cause the one or more processors to perform the steps recited in claim 15.

33. A volatile or non-volatile computer-readable storage medium storing one or more sequences of instructions which, when executed by one or more processors, cause the one or more processors to perform the steps recited in claim 16.

34. A volatile or non-volatile computer-readable storage medium storing one or more sequences of instructions which, when executed by one or more processors, cause the one or more processors to perform the steps recited in claim 17.
